(19) United States
(12) Patent Application Publication
(10) Pub. No.: US 2017/0213428 A1
(43) Pub. Date: Jul. 27, 2017

(54) WIRELESS DOOR CHIME EXTENSION

(71) Applicant: ELFA International Group Inc., Charlestown (KN)

(72) Inventor: Murillo Lamas, Rio de Janeiro (BR)

(21) Appl. No.: 15/390,051

(22) Filed: Dec. 23, 2016

(30) Foreign Application Priority Data
Jan. 26, 2016 (BR) BR202016001636

(51) Int. Cl. G08B 3/10

(52) U.S. Cl. CPC G08B 3/1016

(57) ABSTRACT

A door chime extender device coupled to an existing conventional door chime that is powered when the switch of a conventional electric chime is activated. The device includes a transmitter with an electricity storage circuit that stores sufficient electrical energy to broadcast an electromagnetic signal that is remotely received by a receiver with an alarm output that activates an audio signal. The storage circuit absorbs sufficient energy from the chime's power source when the switch is activated even for a small period of time.

### BACKGROUND OF THE INVENTION

1. Field of the Invention

The present invention relates to a wireless door chime extension and, more particularly, to such an extension that is wireless.

2. Description of the Related Art

Several designs for door chimes have been designed in the past. The chime devices in the prior art require a wired or a wireless connection with independent and additional power requirements for activation. However, it should be noted that these designs (the wired or the wireless systems) have to be independent—there are no interactions between both systems—so, each one needs to work with one specific switch that will have to be directly actuated by the operator. None of them includes only one switch and claimed in order to activate both wired and wireless systems.

The apparatus herein described and claimed utilizes the switch on a conventional electrical chime for activation and power source.

The wireless system, here described, can be installed over the existed wired system, using the same switch and the system already installed. Therefore, both, the wired and wireless systems are activated simultaneously.

In typical use, the button (doorbell S) is pressed not less than 0.3 seconds. The present invention utilizes the electrical energy made available by the switch during this brief period to activate a transmitter to generate an electromagnetic signal that is detected by a receiver that is remotely located. The receiver can be battery powered or preferably powered by a conventional AC outlet that also powers a remote audio alarm, such as a chime.

### SUMMARY OF THE INVENTION

One of the objects of the present invention is to provide a device that can extend the range of the sound of a conventional electrical chime in order to reach remote areas.

It is another object of this invention to provide a chime extender that is activated with a minimal amount of energy obtained from a conventional chime's switch when temporarily activated thereby not requiring a connection to a conventional source of electric power.

It is still another object of the present invention to provide a chime extending with a transmitter assembly that is volumetrically efficient.

It is yet another object of this invention to provide such a device that is inexpensive to implement and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 is a representation of one of the preferred embodiments of the present invention using a conventional electric chime assembly and including a transmitter assembly and a receiving assembly with an audio alarm.

FIG. 2 is a circuit schematic for interface circuit 30 connected to chime and to transmitter assembly 20.

### DETAILED DESCRIPTION OF THE EMBODIMENTS OF THE INVENTION

Referring now to the drawings, where the present invention is generally referred to with numeral 10, it can be observed that it basically includes a conventional electric chime apparatus C, a transmitter assembly 20, chime apparatus C is activated, receiver assembly 40 adapted to detect an electromagnetic signal generated by the transmitter assembly 20 and a sound-generating device D.

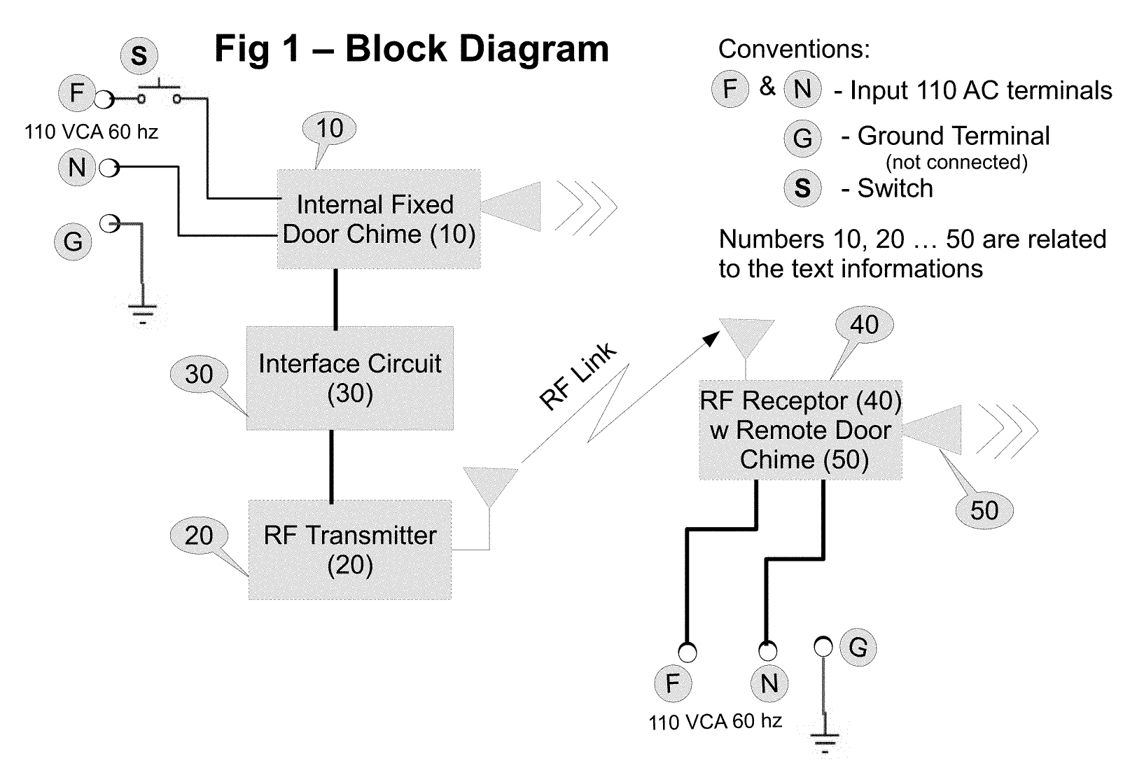

In one embodiment of the invention, as seen in FIG. 1, a transmitter assembly 20 is electronically connected to a conventional electrical chime apparatus C that includes an activating switch S to trigger a sound generating device D. Chime C is typically powered by the public network (110 volts AC) or other depends in the public electric grid. Once switch S is closed, apparatus C is activated as well as transmitter 20. Transmitter 20 generates a predetermined electromagnetic wireless signal that is detected by receiver assembly 40. Receiver assembly 40 includes a sound-generating device D (such as a chime) that is remote from switch S.

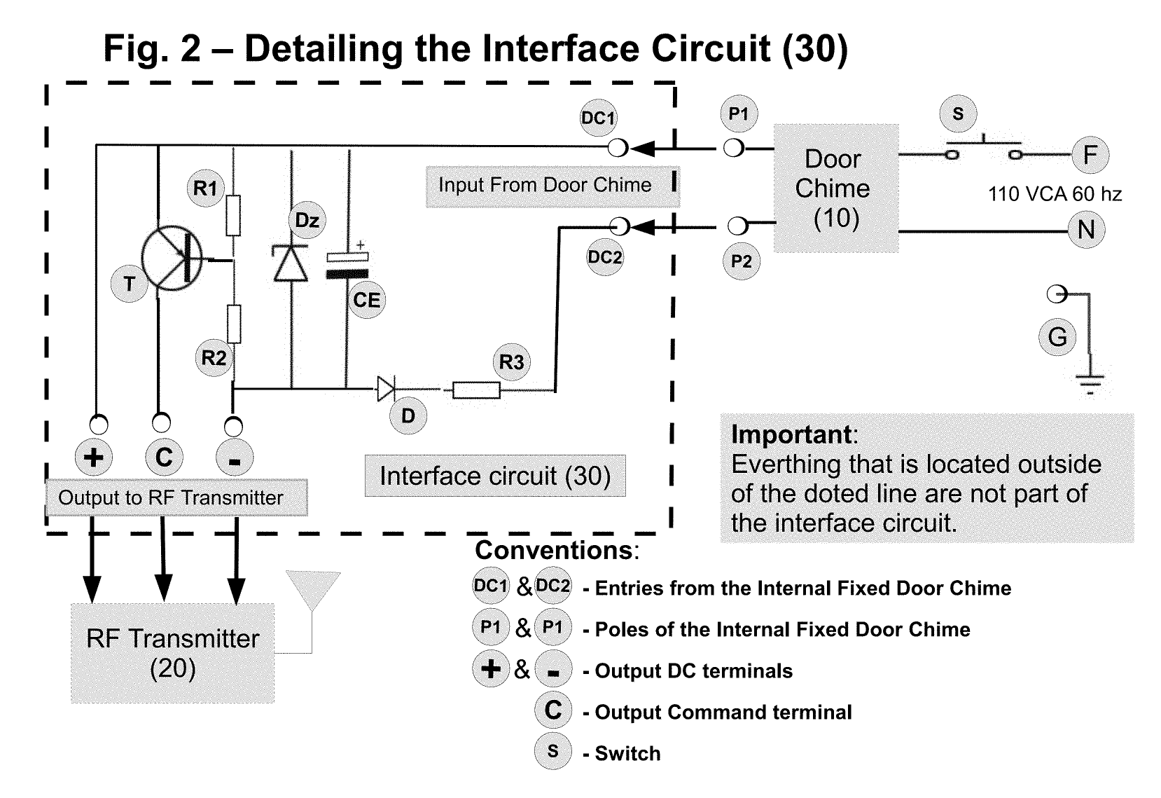

Transmitter assembly 20 includes electricity interface circuit 30 connected to pole P of chime C. When switch S is closed an AC voltage is present temporarily at pole P. It has been found that, users activate switch for no less than 0.3 seconds. Circuit 30 is shown for one of the embodiments in FIG. 2. Circuit 30 receives electricity when switch S is closed.

Interface circuit 30, as shown in FIG. 2, is activated when a user closes switch S in a conventional chime C. An alternating voltage is applied to activate door chime C and interface circuit 30 simultaneously. A typical user activates switch S for 0.3 seconds approximately. Circuit 30 includes, as shown in FIG. 2, capacitor C₁ connected in parallel with Zener diode D_{z1}. In the embodiment shown in FIG. 2, Zener diode D_{z} is a 12 volt, ¼ watt Zener diode and capacitor C₁ is an electrolytic capacitor of 10 microfarads. Thus, the maximum voltage stored by capacitor C₁ will not exceed 12 volts. When a switch S is closed, chime C is activated conventionally and C₁ starts charging to a 12 volt maximum. Port 33 has the same 12 volts that is necessary to activate RF transmitter assembly 20. After the user releases switch S, there is no further supply of energy to door chime C and consequently to transmitter assembly 20. However, capacitor C, is charged and maintains a voltage level at port 32 of at least 9 volts for a sufficient amount of time to ensure that transmitter 35 sends an RF signal that is capable of being detected by receiver assembly 40 of a remote location.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A door chime extender device comprising:
A) an electrically powered chime assembly having a switch S for selectively activating said chime assembly C with a first source of electrical energy;
B) a transmitter assembly including an electricity interface circuit 30 connected to said chime assembly for receiving electrical energy when said switch S is closed and said interface circuit 30 stores sufficient electrical energy that is temporarily made available by said chime C to activate said transmitter assembly and broadcast a predetermined electromagnetic signal; and
C) a receiver assembly connected to a second source of electrical energy, said receiver assembly designed for detecting said signal and generating an alarm output, said receiver assembly being operated remotely from said transmitter assembly when said switch S is activated to connect said first source of electrical energy to said interface circuit 30 for a predetermined time period.

2. The device set forth in claim 1 wherein said time period is not less than 0.3 seconds.

3. The device set forth in claim 2 wherein said transmitter assembly includes a capacitor for storing said energy with a sufficient voltage to broadcast said signal for at least a second predetermined period of time.
